(19) United States
(12) Patent Application Publication
(10) Pub. No.: US 2022/0343722 A1
(43) Pub. Date: Oct. 27, 2022

(54) INFORMATION PROCESSING APPARATUS, INFORMATION PROCESSING METHOD, AND INFORMATION PROCESSING SYSTEM

(71) Applicant: mixi, Inc., Tokyo (JP)

(72) Inventors: Jin FUJISAWA, Tokyo (JP); Sho SHIMIZU, Tokyo (JP); Takayuki MAGATA, Tokyo (JP)

(21) Appl. No.: 17/764,357

(22) PCT Filed: Apr. 12, 2021
(86) PCT No.: PCT/JP2021/015146

§ 371 Date: Mar. 28, 2022

(30) Foreign Application Priority Data
Apr. 28, 2020 (JP) 2020-079076

(51) Int. Cl. G07F 17/32

(52) U.S. Cl. CPC G07F 17/3227; G07F 17/3288

(57) ABSTRACT

It is to improve the interest of betting on the prediction for the ranking of each athlete in the target competition. A computer receives a bet on a prediction for ranking of athletes in a target competition in which a plurality of athletes participate, acquires an activity value of each athlete in the target competition, and determines whether or not prediction content of the received bet was right in view of the ranking of each athlete in the target competition determined based on the activity value of each athlete in the target competition and a correction condition for each athlete with respect to the activity value.

### TECHNICAL FIELD

The present invention relates to an information processing apparatus, an information processing method, and a program.

### BACKGROUND ART

In recent years, bets and lots for predicting a result of sports competition or the like (hereinafter, generically referred to as “bet”) can be placed online via the Internet or the like (see, for example, Patent Literatures 1 to 3).

### CITATION LIST

### Patent Literature

Patent Literature 1: JP 2003-281307A
Patent Literature 2: JP 4493728B
Patent Literature 3: JP 2018-173981A

### SUMMARY OF INVENTION

### Technical Problems

In a conventional betting on the subject of a sports competition or the like, generally predicted are outcomes by team, such as winning or losing of a team that will compete in a game or an acquired score of each team.

Meanwhile, for example, the ranking of each athlete can be determined based on the activity values of each of athletes participating in the competition, and the ranking can be a target of prediction. However, in that case, there is a need for a system that ensures betting with fairness among athletes in consideration of differences in terms of physique, team where he/she belongs, years of experience, position at the time of a game, and the like.

Therefore, an object of the present invention is to provide an information processing apparatus, an information processing method, and a program that can improve the interest of betting on the prediction for the ranking of each athlete in a target competition.

### Solution to Problems

An information processing apparatus according to an aspect of the present invention includes: a reception unit that receives a bet on a prediction for ranking of each athlete of a plurality of athletes in a target competition where the athletes participate; an acquisition unit that acquires an activity value of each of the athletes in the target competition; and a prediction hit determination unit that determines whether or not a prediction content of the bet received was right, in view of ranking of each of the athletes in the target competition determined based on the activity value of each of the athletes in the target competition and a correction condition for each of the athletes with respect to the activity value.

### Advantageous Effects of Invention

According to an aspect of the present invention, it is possible to ensure fairness among athletes by setting a correction condition for each athlete in consideration of individual differences or the like among athletes. As a result, it is possible to improve the interest of betting on the prediction for the ranking of each athlete in the target competition and to promote the betting.

### BRIEF DESCRIPTION OF DRAWINGS

FIG. 1 is a view illustrating a screen for designating a player whose ranking is predicted to be a set ranking among entry screens for betting.

FIG. 2 is a view illustrating a screen for entering a betting value among entry screens for betting.

FIG. 3 is a conceptual diagram of an information processing system including an information processing apparatus of the present invention.

FIG. 4 is a hardware configuration diagram of an information processing apparatus according to an embodiment of the present invention.

FIG. 5 is an explanatory view regarding functions of an information processing apparatus according to an embodiment of the present invention.

FIG. 6 is an explanatory view regarding information on players who participate in a betting target game.

FIG. 7 is an explanatory view regarding an addition condition having been set for each player.

FIG. 8 is an explanatory view regarding information on a bet placed on a betting target game.

FIG. 9 is a view illustrating an example of an achievement value of each player in a game.

FIG. 10 is a view illustrating a bet reception flow in an information processing flow using the information processing apparatus of the present invention.

FIG. 11 is a view illustrating a determination flow for a prediction content of a bet in an information processing flow using the information processing apparatus of the present invention.

### DESCRIPTION OF EMBODIMENTS

An information processing apparatus, an information processing method, and a program of the present invention will be described below in detail with reference to preferred embodiments illustrated in the accompanying drawings.

The embodiments described below are merely examples given to facilitate understanding of the present invention, and do not limit the present invention. The present invention can be modified or improved from the embodiments described below without departing from the gist thereof. The present invention includes equivalents thereof.

The screen examples illustrated in the drawings referred to in the following description are merely examples, and the configuration example of the screen, the content of information to be displayed, graphical user interfaces (GUI), and the like can be freely designed according to specifications of system design, user's preference, and the like, and can be appropriately modified.

[Betting Service]

A service business (hereinafter, referred to as betting service) using the present invention will be described. The present invention is not limited to a case used for the purpose of the following service business, and the present invention may be used, for example, in amusements or games including online games and video games available for betting.

The betting service is a business that handles betting in which a result of target competition is predicted, i.e., bets and lots. The management and mechanism and the like of the business are based on existing public competitions including horse racing, bicycle racing, and boat racing.

The target competition is, for example, a sports competition that is a target of betting. The case described below assumes a game of a team competition in which two or more teams compete for the better score, particularly a league game of basketball. However, the target competition is not limited thereto, and may be a game of another team competition (e.g., soccer, futsal, baseball, softball, handball, volleyball, American football, rugby, ice hockey, lacrosse, and the like), or may be a game of an individual competition (e.g., tennis, badminton, table tennis, golf, bowling, and the like) in which two or more individuals compete.

The target competition may be a competition other than a sports competition, and only needs to be a competition in which a plurality of people participate and compete with each other, including a board game, a video game, a computer game, an online game, and other games, or an amusement in which participants compete with each other for score.

Hereinafter, a league game of basketball that is a betting target is referred to as “target game” in a simplified manner for convenience.

In the following description, an athlete is a player belonging to any one of two or more teams and participating in a target game, and is specifically a player appearing in the target game. More strictly, the athlete is a player (corresponding to a registered athlete) registered for entry as a participating player as described later. Hereinafter, a player registered as a participating player in a target game is simply referred to as “player” for convenience.

The bet is made by predicting the ranking of each player based on his or her activity value in the target game, and specifically, the bet is made by designating a player to be in a set ranking (e.g., first place). The activity value is a value related to the activity of the player in the target game, strictly speaking, a value of the activity related to the game result, and more specifically, an achievement value in the game. The achievement value is an achievement of a player recorded in a game, i.e., a numerical value related to performance of a player in the game, and hereinafter means the score achieved in the game. Meanwhile, the achievement value is not limited to this. In the case of basketball, the achievement value may be the number of shoots, the number of passes, the number of rebounds, the number of steals, the number of fouls, and the like. In the case of another game, the achievement value may be an item similar to the above item.

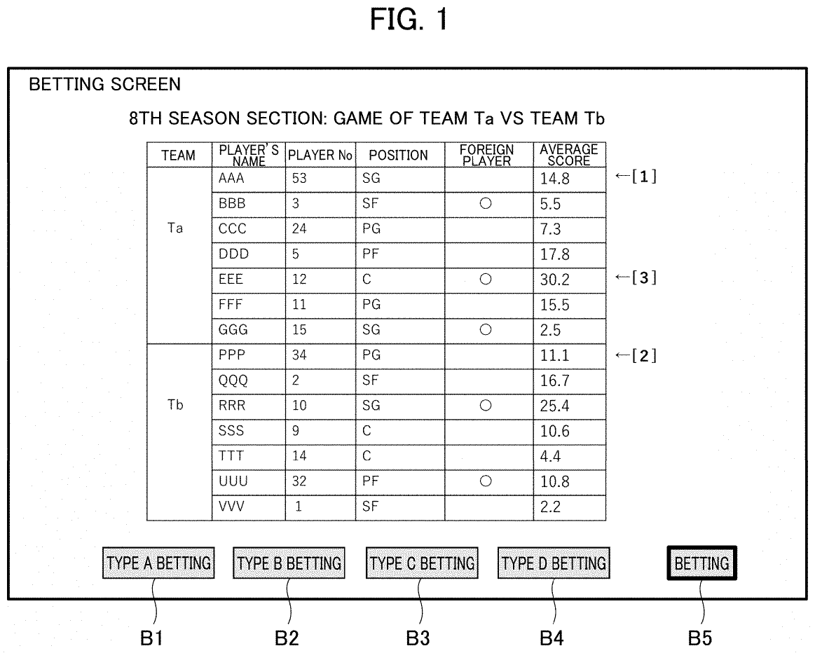

A service user (hereinafter, referred to as bettor) who places a bet can place a bet online through a communication line such as the Internet by operating his/her own terminal. Specifically, the bettor acquires a service account in advance, and then operates his/her own terminal to access a betting site or activates an application program for betting. Accordingly, as illustrated in FIG. 1, on the screen of the terminal of the bettor, players of a target game to be held in the near future are displayed in a state where they can be designated. The bettor can place a bet in his/her own account by designating a player to a set ranking from among the displayed players. The set ranking is a ranking having been set as a rank of the prediction target, and is usually set to the first place, which is the highest ranking, or the first place and consecutive rankings (e.g., second to third places).

Note that the form of betting is not particularly limited. The case described below assumes “type A betting” for designating a player to take first place, “type B betting” for designating one player to take any of first to third places, “type C betting” for designating three players to take first to third places in random order, and “type D betting” for designating three players to take first to third places in order. FIG. 1 illustrates a screen example in a case of designating three players in the form of “type D betting”. In FIG. 1, the player “AAA” assigned with the number [1] corresponds to a player predicted to take first place, the player “PPP” assigned with the number [2] corresponds to a player predicted to take second place, and the player “EEE” assigned with the number [3] corresponds to a player predicted to take third place.

Here, “type C betting” and “type D betting” correspond to bet made by designating as many players whose rankings in the target game are predicted to be any ranking in a set ranking group as the number according to the set ranking group. The set ranking group means a combination of a plurality of set rankings. In “type C betting” and “type D betting”, the set ranking group is a combination of three rankings (first, second, and third places). The number of players in accordance with the set ranking group is, for example, equal to the number of rankings included in the set ranking group, and is three in “type C betting” and “type D betting”.

There may be an additional betting form other than the above four forms. The set ranking of the prediction target may be only the first and second places, may be rankings other than the first to third places, or may be discontinuous rankings (e.g., the first place and the fourth place). The number of players designated as the prediction target may be two, four, or more.

The betting may be made in such a manner that two teams that will compete in a game are put together into one group, and players predicted to be in set ranking are designated in units of games. Alternatively, the betting may be made in such a manner that players predicted to be in set ranking in each team are designated in units of teams.

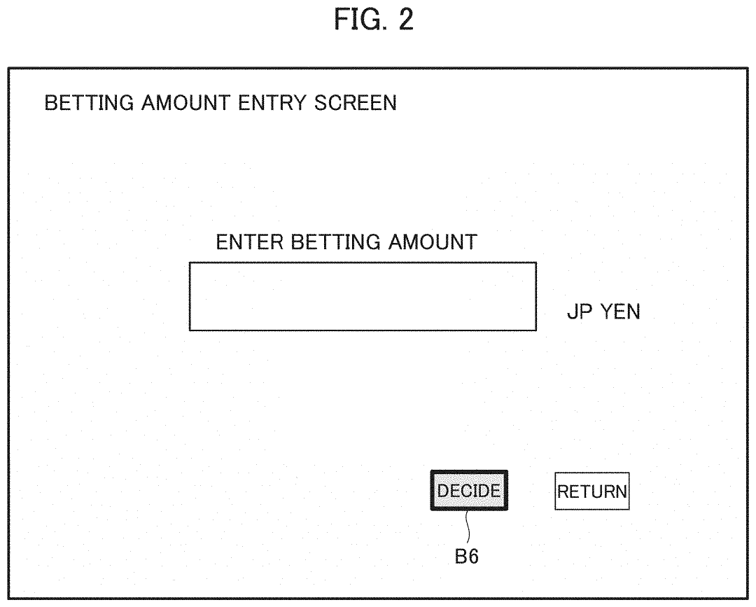

The bettors pay a betting value when placing a bet. The betting value is money such as electronic money used for electronic processing or the like, a dedicated point that can be used in betting services, or the like. An amount of betting value (e.g., an amount of money or the number of points) to be paid by the bettor when placing a bet can be arbitrarily determined, and is entered through an entry screen displayed on the terminal of the bettor as illustrated in FIG. 2. Hereinafter, it is assumed that an amount of money is entered as an amount of betting value.

Following the above-described procedure, the bettor places a bet at least before the start of the target game. At this time, the bettor may place a bet only once per game or may place a bet a plurality of times. In a case of placing a bet a plurality of times, the bettor may change the betting form or the prediction content (a player predicted to take first place or the like) for each betting.

After the game, the ranking in the target game is determined for each player who participated in the target game. In the present invention, the ranking of each player is determined based on the score gained by each player in the game and an addition condition for the score. The addition condition is an example of a correction condition to the score gained in the game, and is specifically an addition value added to the score gained in the game. The addition value is thus provided for the purpose of ensuring fairness among players, and for example, for the purpose of filling a difference between a player with a low score acquisition rate (=probability of scoring in one game) and a player with a high score acquisition rate. That is, the addition value is a handicap point given to a player with a lower score acquisition rate.

The ranking of each player in the target game is determined based on a value (total value) obtained by adding an addition value corresponding to the player to a score gained by the player in the game, and the higher the total value is, the higher the ranking becomes. The case described below assumes that the ranking is determined as the ranking after the target game. However, the present invention is not limited thereto, and for example, the ranking may be determined at a time point when a predetermined time has elapsed from the start of the game.

Note that the addition condition is not limited to the addition value, and may be a coefficient by which the score gained in the game is multiplied. The correction condition is not limited to the addition condition, and for example, a subtraction condition (specifically, a subtraction value or a subtraction coefficient) may be applied instead of the addition condition to a player with a relatively high score acquisition rate.

When the ranking of each player in the target game is determined, the operating company of the betting service determines whether the prediction content of the bet for the target game was right or not. In other words, it is determined whether or not a player predicted to a set ranking in the target game has actually been ranked as predicted.

The bettor whose prediction content was right is provided with a reward for winning, and specifically, a dividend corresponding to the payment amount of betting value (hereinafter, referred to as betting amount) is repaid. The dividend is determined by multiplying the betting amount by a dividend rate (odds). As a method of determining the dividend rate (odds) and a method of repaying the dividend, known methods can be used. For example, the dividend rate may be determined in accordance with Parimutuel betting or the like, and the dividend may be repaid by a method similar to a method of repaying those who made a right prediction in an Internet betting in a general public competition.

A series of betting and post-betting processing is performed in the manner described above. The case described below assumes that betting is made for each game, and the above-described addition value (addition condition) is updated for each game in association with the betting.

Specifically, in a league game of basketball, a game is held in each of a plurality of sections set in one season, and each game is a betting target. The addition value fluctuates for each game, in other words, is reviewed for each section and updated each time. Here, one season corresponds to a predetermined period, and is usually a period of one year or half years. The section corresponds to a unit period, and is usually a period of two to three days set to define the order of the respective games held in one season.

Note that the present invention is not limited to the case where the addition value is updated for each section (each game), and the addition value may be a constant value that remains unchanged throughout one season.

[Information Processing System]

Next, an information processing system including the information processing apparatus of the present invention will be described.

The above information processing system is constructed to implement the betting service online, and is hereinafter referred to as “betting system S”.

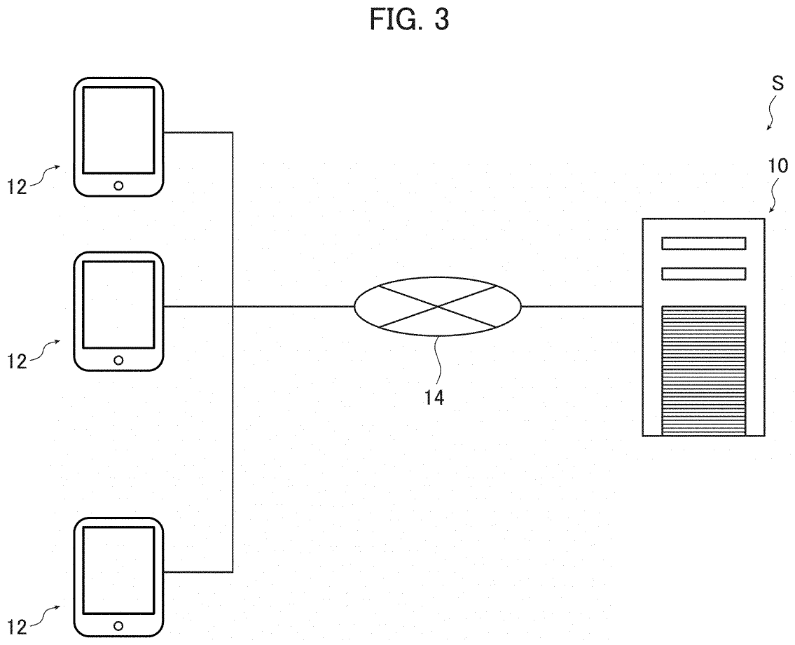

As illustrated in FIG. 3, the betting system S includes a server for central management (hereinafter, the server 10) and a user terminal 12 of the bettor, and these devices are communicably connected to each other through a communication network 14. Note that the number of user terminals 12 is originally the number corresponding to the number of bettors, and in FIG. 3, the number of user terminals 12 is three for convenience of illustration. However, the number of user terminals 12 may be any number.

The server 10 corresponds to an information processing apparatus according to an embodiment of the present invention, and is, for example, a computer the operating company of betting service uses to implement the betting service. The server 10 acquires and stores various types of information necessary for the betting service, and executes various types of information processing regarding the betting service using the acquired information.

Examples of the main information processing by the server 10 include processing of receiving a bet from each bettor, processing of acquiring an achievement value of each player in the target game, processing of determining whether or not the prediction content of a bet was right, and processing of providing a reward to a bettor whose prediction was hit (specifically, processing of repaying the dividend).

Note that the server 10 may be configured of one computer alone, or may be configured of a plurality of parallel distributed computers.

The user terminal 12 is a device operated by the bettor when placing a bet, and is configured of a personal computer, a smartphone, a mobile phone, a tablet terminal, a television set capable of information input, a wearable terminal or the like. The bettor has acquired an account for betting, and logs in the server 10 with his/her own account when placing a bet. At this time, the bettor may be required to enter authentication information (e.g., account name, password, and the like).

The user terminal 12 communicates with the server 10 to receive and develop betting data, and displays information (e.g., the entry screen illustrated in FIGS. 1 and 2) indicated by the data. The bettor places a bet by operating the user terminal 12 while viewing the displayed information. In this manner, information necessary for betting (betting information described later) such as a designation result of a player whose ranking is predicted to be a set ranking and a betting amount is entered through the user terminal 12. The betting information having been entered is sent from the user terminal 12 to the server 10.

Using the user terminal 12, the bettor can confirm, after the game, whether or not the prediction content of the bet was right, and can confirm the amount of the dividend (amount of repayment) when the prediction was hit. The bettor whose prediction was hit can be repaid the dividend by performing a predetermined repayment operation with the user terminal 12 or operating a dividend repayment dispenser (not illustrated) installed in a predetermined place.

Note that the betting is not limited to be made through the user terminal 12 possessed by the bettor, and may be made through a betting terminal (not illustrated) installed in a game venue, a game watching venue (e.g., a public screening site), or the like. In this case, the bettor places a bet by visiting the installation place of the betting terminal and operating the terminal.

[Configuration Example of Information Processing Apparatus of Present Invention]

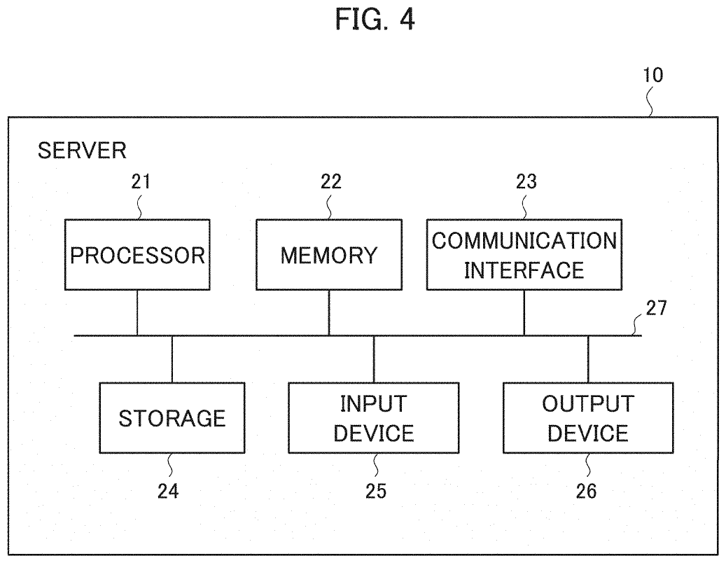

Next, a configuration example of the information processing apparatus according to an embodiment of the present invention, i.e., the server 10, will be described. As illustrated in FIG. 4, the server 10 includes hardware devices such as a processor 21, a memory 22, a communication interface 23, a storage 24, an input device 25, and an output device 26, and these devices are electrically connected via a bus 27.

In the server 10, a program for an operating system (OS) and an application program for a betting service are installed as software. These programs correspond to the “program” of the present invention. The processor 21 operates according to the above program, whereby the server 10 functions as the information processing apparatus of the present invention and executes a series of information processing related to the betting service.

The processor 21 is preferably configured of a central processing unit (CPU), a micro-processing unit (MPU), a micro controller unit (MCU), a graphics processing unit (GPU), a digital signal processor (DSP), a tensor processing unit (TPU), an application specific integrated circuit (ASIC), or the like.

The memory 22 is preferably configured of a semiconductor memory such as a read only memory (ROM) and a random access memory (RAM).

The communication interface 23 is preferably configured of, for example, a network interface card, a communication interface board, or the like. The standard of data communication by the communication interface 23 is not particularly limited. Examples thereof include communication by a wireless LAN based on Wi-fi (registered trademark), communication by a 3G, 4G, or 5G mobile communication system, and communication based on long term evolution (LTE).

The storage 24 is preferably configured of a flash memory, a hard disc drive (HDD), a solid state drive (SSD), a flexible disc (FD), a magneto-optical (MO) disc, a compact disc (CD), a digital versatile disc (DVD), a secure digital card (SD card), a universal serial bus memory (USE memory), or the like. The storage 24 may be built in the housing of the server 10 or may be externally connected to the server main body. Alternatively, the storage 24 may be configured of an external computer communicably connected to the main body of the server 10, specifically, a database server or the like.

The input device 25 is preferably configured of, for example, a keyboard, a mouse, a touch-screen, or the like. The output device 26 is preferably configured of, for example, a display, a speaker, and the like.

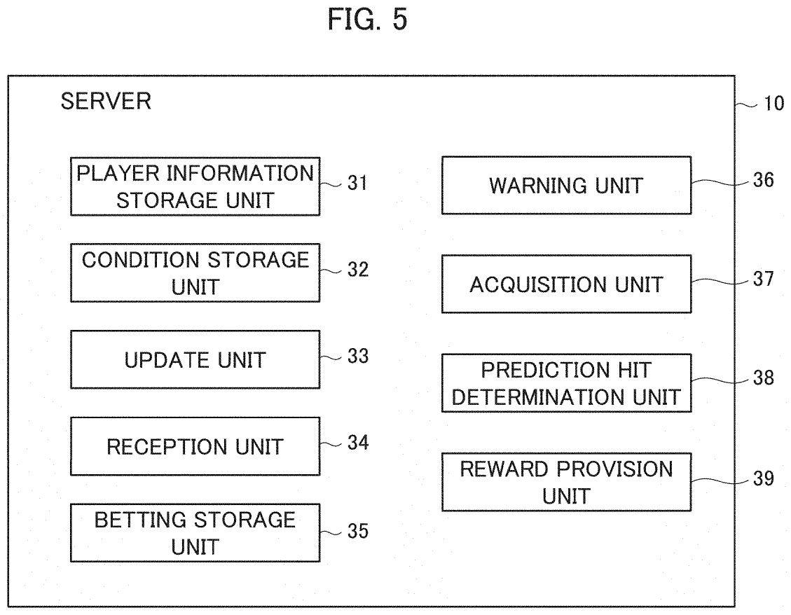

The configuration of the server 10 will be described more in terms of functions. As illustrated in FIG. 5, the server 10 includes a player information storage unit 31, a condition storage unit 32, an update unit 33, a reception unit 34, a betting storage unit 35, a warning unit 36, an acquisition unit 37, a prediction hit determination unit 38, and a reward provision unit 39. Each of these functional units is implemented by cooperation of the hardware devices of the server 10 including the processor 21, an operating system (OS) installed in the server 10, and an application program for betting service.

Each functional unit will be described below.

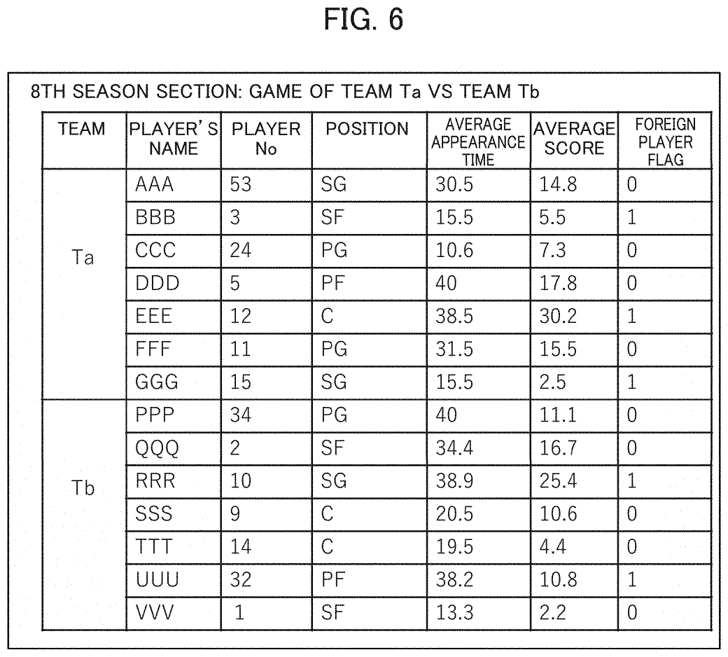

The player information storage unit 31 stores information on a player (corresponding to a registered athlete) registered as a player participating in a target game. The player information storage unit 31 stores information (hereinafter, referred to as player information) on the players, as illustrated in FIG. 6, including the name of each player, the player number, the position in game, the average game appearance time (minutes), the average score, and the foreign player flag, for each of two teams that will compete in the target game. Other information (e.g., age, height, total score in the present season, and the like) may be included as the player information.

The average game appearance time and the average score correspond to the performance activity values of each player in a previously held game (corresponding to the held competition), and are respectively an average value of appearance time in the latest N games (N is a natural number of 2 or more, and the same applies hereinafter) and an average value of scores acquired in the latest N games. These values are referred to when an addition value for each player is set.

The foreign player flag is information indicating whether or not the player is a foreign player. For example, the foreign player flag is expressed as a binary value (a value of 0 or 1), and “1” means that the player is a foreign player. The reason why the foreign player flag is stored as player information is because in a league game of basketball, foreign players fall under limited athletes where the number of foreign players (spot) of each team who can participate at the same time in one game is limited to a predetermined number or less. More specifically, for example, the number of foreign players who can register for entry in each game is i (i is a natural number of 2 or more), and the number of foreign players who can participate at the same time in the game among the foreign players registered for entry is set to j (j is a natural number equal to or less than i).

Note that, in the present description, a “foreigner” is a citizen having a different nationality from the country hosting the target game, and is a citizen other than the Japanese nationality hereinafter. Athletes (limited athletes) the number of whom allowed to participate in a game is limited are not limited to foreign players and may include naturalized players. The number of foreign players who can participate at the same time in one team may be provided with an exception, and a foreign player whose nationality is a predetermined country, for example, may be provided with a special spot (spot prepared separately from a spot for a foreign player whose nationality is other than a predetermined country).

The player information storage unit 31 stores player information on the players participating in each of target games held in a predetermined section. The game held in a predetermined section is a game having not more than a predetermined number (e.g., about one week) of remaining days until the section, and specifically corresponds to a game held in the next section. The game held in a predetermined section varies as the days pass. Accordingly, the player information stored in the player information storage unit 31 is updated as needed, and specifically, the player information of the game having been held is deleted, and the player information of the game scheduled to be held in the next section is newly registered.

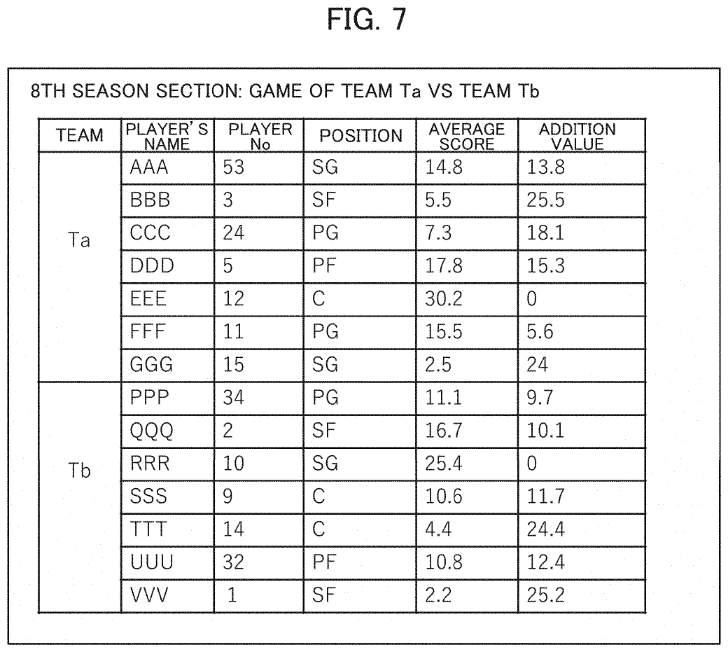

The condition storage unit 32 stores the above-described addition condition, specifically, the addition value. The addition value is set for each of a plurality of players participating in the target game. Therefore, as illustrated in FIG. 7, the condition storage unit 32 stores an addition value for each player for each target game.

The addition value is set for each player according to the past average game appearance time or average score (performance activity value), and is set by the operating company of the betting service before the game starts, for example. The procedure for setting the addition value is not particularly limited. For example, in the same team, a player with the highest average score in the latest N games may be set as a reference player, and an addition value for each player of the team the reference player belongs to may be set according to a difference between the average score of each player and the average score of the reference player.

For a newly registered player having no past performance activity value such as a new player, the addition value may be set as a predetermined value, specifically, a value unique to the newly registered player, regardless of the above setting procedure.

That is, the addition value is to be acquired before the addition value is stored in the condition storage unit 32. The method of acquiring the addition value is not particularly limited, and the addition value may be input through the input device 25 of the server 10, or may be received and obtained from an external terminal that manages the addition value by communication between the server 10 and the external terminal.

The update unit 33 updates the addition condition (addition value) stored in the condition storage unit 32 for each section. That is, the addition value applied to the same player is updated for each section by the update unit 33 and reviewed for each game. The update of the condition by the update unit 33 may be automatically performed at timing of or immediately before the change of the section, or may be performed when the operator of the server 10 inputs a new addition condition to the input device 25.

The reception unit 34 receives a bet placed by the bettor for the target game, and specifically receives a bet through communication with the user terminal 12 via the communication network 14. The bet received by the reception unit 34 is information indicating content of the bettor's prediction. The prediction content indicates among players (registered athletes) who participate in the target game, a player (designation result) designated by the bettor as a player whose ranking in the target game is predicted to be a set ranking.

In order to receive the bet placed by the bettor, the reception unit 34 first notifies the bettor of the players who participate in the target game in a state of being able to be designated. “Notify of the players in a state of being able to be designated” means, for example, that the player information on the player participating in the target game is displayed in a list format on the user terminal 12 of the bettor. Specifically, the reception unit 34 transmits the display data of the betting entry screen illustrated in FIG. 1 to the user terminal 12. A specific bet reception procedure including the betting entry screen will be described in detail later.

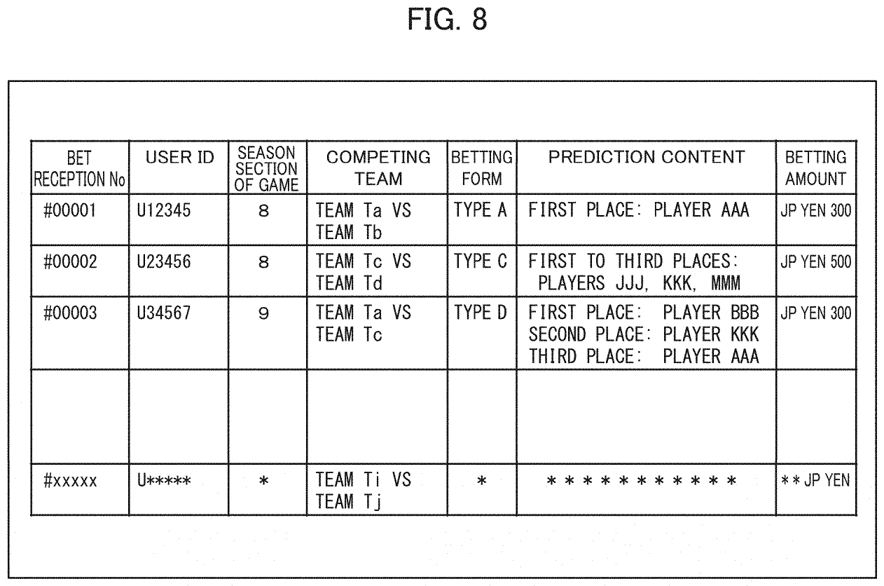

The betting storage unit 35 stores, for each received bet, information on betting (hereinafter, referred to as betting information) including prediction content of the bet received by the reception unit 34. For example, as illustrated in FIG. 8, the bet reception number, the user ID (account name) of the bettor, the section and the compete team of the target game, the betting form, the prediction content (player whose ranking is predicted to be a set ranking), the betting amount, and the like are stored as betting information. Other information (e.g., personal information of the bettor, information on a method of repayment of the dividend, and the like) may be included as the betting information.

The warning unit 36 executes warning processing as necessary in a case where betting is made in the form of type C betting or type D betting (i.e., a case where two or more players are designated and betting is made). When the reception unit 34 receives a bet in which two or more players having a predetermined relationship are designated, the warning processing is executed for the bettor who place the bet. The two or more players having a predetermined relationship are two or more players satisfying the following condition (1) or condition (2).

Condition (1): Two or more players belong to the same team and have the same position in the game.

Condition (2): Two or more players belong to the same team and both of them fall under foreign players, and the number of players falling under the foreign players exceeds the number of players who can participate in one game (i.e., a predetermined number j).

In a case where two or more players satisfying the condition (1) are designated, the positions of the players overlap, and hence one player does not appear in the game or even if the player appears in the game in turn, the appearance time is shortened. In such a situation, the probability that the prediction is missed becomes high, and thus warning processing is executed for notifying the bettor of the fact.

In a case where two or more players satisfying the condition (2) are designated, the number of foreign players who can participate in one game at the same time from the same team is limited to a predetermined number j or less, and hence the number of foreign players exceeding the predetermined number j cannot appear in the game or even if the players appear in the game in turn, the appearance time is shortened. In such a situation, the probability that the prediction is missed becomes high, and thus warning processing is executed for notifying the bettor of the fact.

The warning processing only needs to be any processing that can warn the bettor and call the bettor's attention. For example, in the warning processing, control data for warning may be transmitted to the user terminal 12 to display a warning message or generate a warning sound on the user terminal 12. After the warning processing is executed, the bettor who has received the warning may be encouraged to re-bet. In that case, it is more preferable to discard the bet received before the warning and to receive a bet again.

When a target game is held, the acquisition unit 37 acquires an achievement value of each player who participated in the same game, specifically, the value of the score gained by each player in the game. The method by which the acquisition unit 37 acquires the achievement value is not particularly limited. For example, the achievement value may be input through the input device 25 of the server 10. Alternatively, the achievement value may be received and obtained from, through communication with, another server that distributes the news of the game result after the game. Alternatively, the achievement value of each player may be determined by capturing a scene of the target game with a video camera or the like and analyzing a file of the captured moving image.

The prediction hit determination unit 38 determines whether or not the prediction content of the bet received by the reception unit 34 was right, i.e., whether or not a player predicted to be ranked as a set ranking in the target game has actually been ranked as predicted. When the target game ends, the prediction hit determination unit 38 reads betting information received by the reception unit 34 for the game from the betting storage unit 35, and specifies the prediction content from the betting information having been read.

The ranking of each player in the target game is determined based on the sum of the achievement value of each player acquired by the acquisition unit 37 for the same game and the addition value for the player who has participated in the game. At this time, the player to which the addition value is added may be limited to a specific player (corresponding to a specific athlete) whose achievement value in the target game satisfies a predetermined condition from the viewpoint of fairness, and for example, may be limited to a player whose score gained in the target game is one point or more. In this case, the ranking of each player in the target game is determined based on the achievement value (score) of the specific player in the game and the addition value corresponding to the specific athlete.

Based on the ranking of each player in the target game, the prediction hit determination unit 38 determines whether or not the prediction content of the bet for the game was right. At this time, in a case where the player to which the addition value is added is limited to the specific player as described above, the prediction hit determination unit 38 determines, based on the ranking of each specific athlete in the target game, whether or not the prediction content of the bet for the target game was right.

Note that the present invention is not limited to the above case, and regardless of whether or not being a specific player, the ranking of all players who participated in the target game may be determined, and whether or not the prediction content of the bet for the target game was right may be determined based on the ranking of each player. In this case, for the player who participated in the target game but gained no score, it is preferable that the achievement value is corrected by, for example, multiplying the achievement value (i.e., the same value as the addition value) to which the addition value is added by 0, and the ranking is determined from the corrected achievement value. In this way, a player who gained no score in the game is ranked, but is not ranked high. This makes it possible to perform determination in substantially the same manner as the case of determining whether or not the prediction content was right based on the ranking of the specific player.

In a case where the prediction content of the bet was right, the reward provision unit 39 provides a reward to the bettor who made a right prediction, and specifically, executes processing for repaying the dividend. The reward provision unit 39 determines the dividend according to a betting amount paid by the bettor when placing a bet, and sets the dividend as, for example, an amount of money obtained by multiplying the betting amount by odds according to the prediction content.

[Information Processing Flow]

Next, an information processing flow regarding betting will be described. This information processing flow is executed by the betting system S. The information processing flow described below adopts the information processing method of the present invention. In other words, each step in the information processing flow described below corresponds to the component of the information processing method of the present invention.

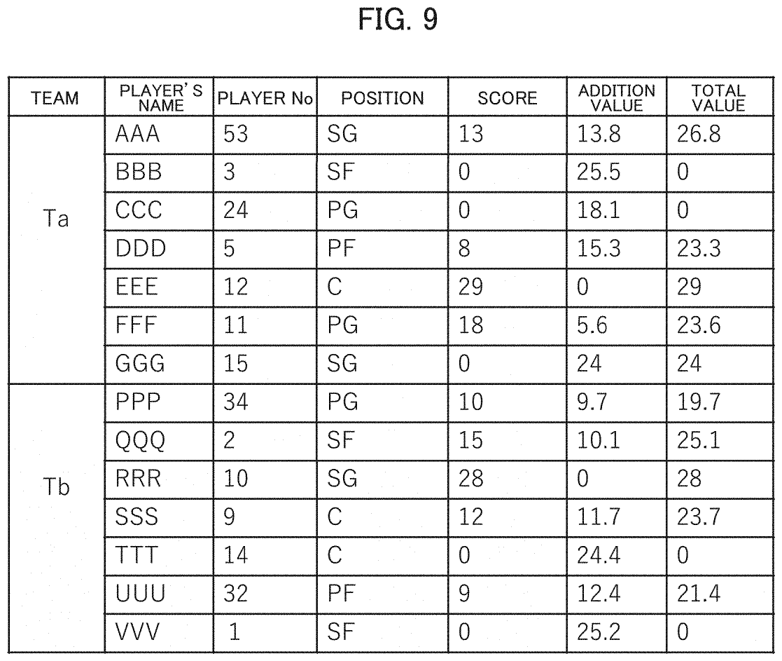

Hereinafter, a case where a bettor X places a bet for a basketball game Gk held in section k (k is a natural number) will be described as a specific example. In the game Gk, it is assumed that a team Ta and a team Tb compete each other, and the achievement value of each player in the game Gk is as illustrated in FIG. 9.

The information processing flow regarding betting is divided into a bet reception flow for receiving a bet and a determination flow for determining whether or not the prediction content of the bet is right. Each processing flow will be described below.

(Bet Reception Flow)

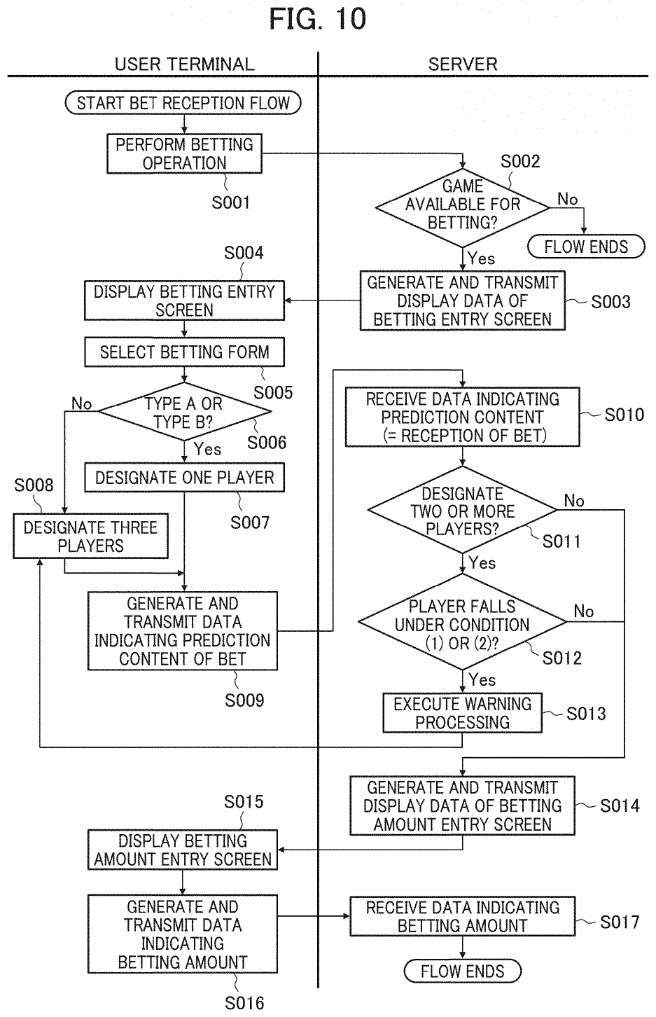

The bet reception flow is implemented by the computer constituting the server 10 and the user terminal 12, and proceeds according to the flow illustrated in FIG. 10. Specifically, first, the bettor X performs a betting operation on his/her user terminal 12 (S001). At this time, the bettor X selects the game Gk as the target game, and the selection result is sent from the user terminal 12 of the bettor X to the server 10 via the communication network 14.

The server 10 that has received the selection result from the user terminal 12 determines whether or not the selected game Gk is a game that can be betted at the current time point (S002). If the game Gk is a game that can be betted at the current time point, the server 10 proceeds to the next step S003. On the other hand, if the betting for the game Gk cannot be made because the current time point is before the start of the bet reception for the game Gk or the like, the processing ends at that time point.

In step S003, the server 10 generates display data of an entry screen for designating a player as data for notifying of the players who participate in the game Gk in a state of being able to be designated, and transmits the display data to the user terminal 12 of the bettor X. On the user terminal 12 of the bettor X, the display data sent from the server 10 is received and developed, so that the betting entry screen illustrated in FIG. 1 is displayed (S004).

The betting entry screen displays player information of the players who participate in the game among the players belonging to the teams Ta and Tb that compete in the game Gk. Specifically, as illustrated in FIG. 1, the player names, the numbers, the positions, whether or not being a foreign player, the average scores in the latest N games, and the like are displayed. As illustrated in FIG. 1, the betting entry screen displays the addition condition, specifically, the addition value, set for each player participating in the game Gk.

Selection buttons B1 to B4 in a betting format are arranged in a lower part of the betting entry screen. The bettor X selects any one of “type A betting” to “type D betting”, and touches or clicks the button corresponding to the selected betting form (S005). If “type A betting” or “type B betting” is selected, the bettor X predicts and designates one player to take first place or any of first to third places from among the players displayed on the screen (S006, S007). On the other hand, if “type C betting” or “type D betting” is selected, the bettor X predicts and designates three players to take first to third places from among the players displayed on the screen (S006, S008).

Note that the method of designating the player is not particularly limited, and for example, the player may be designated by touching or clicking the column of the player to be designated on the betting entry screen illustrated in FIG. 1. Although in an aspect different from FIG. 1, if players are displayed in the form of a pull-down list, the player to be designated may be picked up from the pull-down list. If an entry field for entering the result of the player designation is provided, the name or the like of the player thus designated may be entered in the entry field.

Thereafter, when the bettor X touches or clicks a betting button B5 arranged at the lower part of the betting entry screen, data indicating the prediction content of the bet, i.e., data indicating a result of the player designation by the bettor X is generated by the user terminal 12 of the bettor X. The generated data is transmitted to the server 10 via the communication network 14 (S009).

The server 10 receives the bet by receiving the data indicating the prediction content of the bet (S010). Thereafter, the server 10 determines whether two or more players are designated in the received prediction content of the bet, in other words, whether or not the betting format is either of type C betting and type D betting (S011). If two or more players are designated, the server 10 determines whether or not the designated players are two or more players falling under the condition (1) or (2) described above (S012).

In a case where a single player is designated, and in a case where the designated players are not the two or more players falling under the condition (1) or (2), the server 10 proceeds to step S014.

On the other hand, in a case where two or more players are designated, and in a case where the designated players are the two or more players falling under the condition (1) or (2), the server 10 executes warning processing for the bettor X (S013). This causes the user terminal 12 of the bettor X to display a warning message, generate a warning sound, and the like. If the warning processing is executed, in the user terminal 12 of the bettor X who has received the warning, the process returns to step S008, and players predicted to take the first to third places are designated again (redesignated). However, the present invention is not limited thereto, and for example, the process may directly proceed to step S014 without returning to step S008 after the warning processing is executed.

In step S014, the server 10 generates display data of the betting amount entry screen as data for determining the amount of betting value (money) to be betted, and transmits the display data to the user terminal 12 of the bettor X. On the user terminal 12 of the bettor X, the display data sent from the server 10 is received and developed, so that the betting amount entry screen illustrated in FIG. 2 is displayed (S015).

The bettor X sets the betting amount, enters the amount on the entry screen, and then touches or clicks a decision button B6 provided at a lower part of the entry screen. With this as a trigger, the user terminal 12 generates data indicating the entered betting amount, and transmits the generated data to the server 10 through the communication network 14 (S016). When the server 10 receives the data indicating the betting amount (S017), the bet reception flow ends at that time point.

The betting information received by the server 10, specifically, the prediction content of the bet indicated by the data received in step S010 and the betting amount indicated by the data received in step S017 are put together as betting information for one record and then stored in the memory 22 or the storage 24.

(Determination Flow)

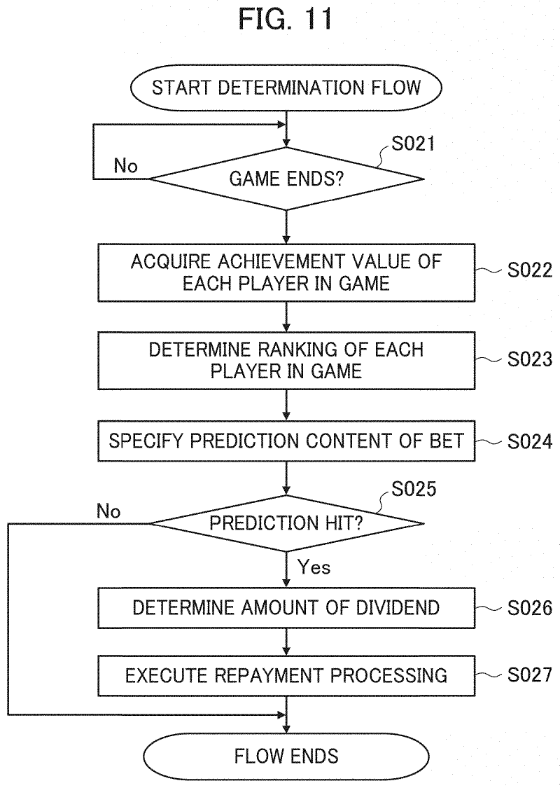

The determination flow is mainly implemented by the computer constituting the server 10, and proceeds according to the flow illustrated in FIG. 11. More specifically, after the game Gk ends (Yes in S021), the server 10 acquires an achievement value of each player in the game Gk, specifically, the score value in the game for each player (S022). The method of acquiring the score of each player in step S022 is not particularly limited. For example, as mentioned earlier, news regarding the result of the game Gk including the score of each player may be obtained from an external server, and the score of each player in the game Gk may be calculated based on the news.

The value of the score of each player in the game Gk is as illustrated in FIG. 9. Among the 14 players registered as the players participating in the game Gk, the nine players excluding “BBB”, “CCC”, “GGG”, “TTT”, and “VVV” have scored in the game, and the server 10 recognizes these nine players as specific players.

The server 10 sums up the score of each player acquired in step S022 and the addition value corresponding to each player, and determines the ranking of each player in the game Gk (S023). At this time, the server 10 reads the addition values of the players participating in the game Gk of the kth section from the betting storage unit 35, obtains the sum value for each of the specific players who have scored, and determines the ranking of each specific player. In the case illustrated in FIG. 9, the player “EEE” is in first place, the player “RRR” is in second place, and the player “AAA” is in third place.

Next, the server 10 specifies the prediction content of the bet placed for the game Gk (S024). Specifically, the server 10 reads the betting information on the bet for the game Gk from the betting storage unit 35, and specifies the prediction content from the read betting information. Note that, if a plurality of persons place bets for the game Gk, the server 10 repeatedly implements steps (S024 to S026) in and after step S024 the same number of times as the number of bets.

Then, the server 10 collates the ranking of each player (strictly speaking, each specific player) in the game Gk determined in step S023 with the prediction content of the bet specified in step S024, and determines whether or not the prediction content of the bet was right. That is, the server 10 determines whether or not the player predicted to be ranked as a set ranking has actually been ranked as predicted (S025). Thereafter, the server 10 determines the amount of the dividend as a reward according to the betting amount paid at the time of betting for which the prediction content was right (S026). The server 10 executes dividend repayment processing for the bettor who made the right prediction (S027).

At the time point when the series of processing described above ends, the determination flow for the winning of the game Gk ends.

### Conclusions

The information processing apparatus of the present invention includes the reception unit 34 that receives a bet, the acquisition unit 37 that acquires an activity value of an athlete, and the prediction hit determination unit 38 that determines whether or not the prediction content of the received bet was right. The reception unit 34 receives a bet on prediction as to the ranking of each athlete in a target competition in which a plurality of athletes (players) participate. The acquisition unit 37 acquires an activity value of each athlete in the target competition. The prediction hit determination unit 38 determines whether or not the prediction content of the received bet was right from the ranking of each athlete in the target competition determined based on the activity value of each athlete in the target competition and the correction condition for each athlete with respect to the activity value.

According to the information processing apparatus of the present invention having the above configuration, a correction condition in consideration of an individual difference (specifically, differences in physique, age, ability, experience, and the like) among athletes is set for the ranking of each athlete in the target competition. Then, the ranking of each athlete is determined based on the activity value corrected by the correction condition. Due to such a mechanism, it is possible to treat each athlete more fairly when placing a bet on the prediction for the ranking of each athlete in the target competition, and thus the interest of betting is improved. This makes it possible to promote betting and its related business.

The information processing apparatus of the present invention may include a reward provision unit. In this case, it is preferable that the reward provision unit 39 determines a reward according to a betting value paid by a bettor when placing the bet and provides the reward to the bettor, if prediction content of the betting was right. By providing a reward to the bettor whose prediction in the bet was hit, it is possible to provide motivation for betting, further improve the interest of betting, and further promote betting.

Having an athlete whose activity value in a target competition satisfying a predetermined condition as a specific athlete, the prediction hit determination unit 38 may determine whether or not prediction content of the bet was right based on ranking of each of the specific athletes in the target competition determined based on the activity value of each of the specific athletes in the target competition and the correction condition corresponding to the specific athlete. By applying the correction condition to the activity value of the specific athlete satisfying the predetermined condition, it is possible to appropriately determine the ranking of each athlete in the target competition. When the above embodiment is described as an example in an easy-to-understand manner, it is possible to avoid a situation in which the ranking of the player who gains no score takes higher place due to the addition condition (addition value).

The activity value of the athlete acquired by the acquisition unit 37 may be an achievement value of the athlete in the target competition, and the correction condition may be an addition condition for the achievement value. In this case, if the addition condition for the achievement value of each athlete is set based on individual differences among the athletes, the ranking of the athletes can be appropriately determined in consideration of the individual differences among the athletes. As a result, it is possible to treat each athlete more fairly, and the interest of betting on the prediction for the ranking of each athlete is further improved.

The reception unit 34 may notify of a plurality of preliminarily registered athletes in a state of being able to be designated, and may receive a bet indicating a designation result as to the registered athlete whose ranking in the target competition is predicted to be a set ranking. In this case, since the bet is made by designating an athlete predicted to be ranked in a set ranking from among the plurality of registered athletes, simpler betting is implemented.

The information processing apparatus of the present invention may include the condition storage unit 32 that stores a correction condition. It is preferable that the condition storage unit 32 stores the correction condition set for each athlete according to the performance activity value of each athlete in a previously held competition. In this case, since the correction condition to be applied to each athlete is determined based on the performance activity value of each athlete in the previously held competition, the correction condition becomes a condition in which individual differences among athletes are appropriately considered. As a result, it is possible to treat each athlete yet more fairly, and the interest of betting of the prediction for the ranking of each athlete is yet further improved.

The information processing apparatus of the present invention may further include the update unit 33 that updates the correction condition stored in the condition storage unit 32. In a case where the target competition is held in each of a plurality of unit periods (specifically, sections) set within a predetermined period, the update unit 33 preferably updates the correction condition for each athlete in each unit period. In this manner, the correction condition is updated in each unit period (in other words, for each game), and is also reflected in the ranking of each athlete determined based on the correction condition. As a result, it is possible to further improve the interest of betting.

The information processing apparatus of the present invention may further include the warning unit 36 that executes warning processing. It is preferable that, in a case where the bet is made by designating as many athletes whose rankings in the target competition are predicted to be any ranking in a set ranking group as the number according to the set ranking group, the warning unit 36 executes warning processing for the bettor who has placed a bet when the reception unit 34 receives the bet in which two or more athletes having a predetermined relationship are designated. This makes it possible to warn and call attention to a person (bettor) who placed a bet by designating two or more athletes having a predetermined relationship.

In the above configuration, the target competition may be a game of team competition in which two or more teams compete for the better score. In this case, the warning unit 36 preferably executes warning processing for the bettor when the reception unit 34 receives a bet designating two or more athletes having a relationship falling under the following condition (1).

Condition (1): Two or more athletes belong to the same team and have the same position in the game.

The above configuration makes it possible to notify the bettor that the bet is disadvantageous to the bettor. Specifically, in a case where the bet is made by designating a plurality of athletes having the same position in the same team, one athlete among them cannot participate in the game or takes turns, and thus the appearance time is shortened. Therefore, it is less likely that the above-mentioned athlete takes high place, and the prediction hit probability of the bet in which the ranking of the athlete is predicted to be high is lowered. By performing the warning processing in such a case to call attention, the bettor can avoid suffering a disadvantage.

In the above configuration, it is more preferable that the warning unit 36 executes warning processing for the bettor when the reception unit 34 receives a bet in which two or more athletes having a relationship falling under the following condition (2) are designated.

Condition (2): Each of two or more athletes belongs to the same team, and falls under the limited athletes the number of whom allowed to participate in each team in one game is limited, and the number of athletes falling under the limited athletes exceeds a predetermined number.

Similarly to the above-described configuration, the foregoing configuration makes it possible to notify the bettor that the bet is disadvantageous for the bettor. Specifically, in a case where the bet is made by designating more than a predetermined number of athletes falling under the limited athletes (e.g., foreign player) who belong to the same team and the number of whom allowed to participate in one game from each team is limited to a predetermined number or less, excess limited athletes exceeding the number of athletes allowed to participate in the game cannot participate in the game, or the athletes take turns and thus their appearance time is shortened. Therefore, the excess limited athletes exceeding the predetermined number are less likely to be ranked high, and the prediction hit probability of a bet in which the ranking of the limited athlete is predicted to be ranked high is lowered. In such a case, by performing the warning processing to call attention, the bettor can avoid suffering a disadvantage.

The information processing method of the present invention is characterized in that a computer receives a bet on a prediction for ranking each athlete of a plurality of athletes in a target competition in which the athletes participate, a computer acquires an activity value of each of the athletes in the target competition, and a computer determines whether or not prediction content of the received bet was right in view of ranking of each of the athletes in the target competition determined based on the activity value of each of the athletes in the target competition and a correction condition for each of the athletes with respect to the activity value. According to such the information processing method, individual differences among athletes are taken into consideration when determining the ranking of each athlete in the target competition. As a result, it is possible to treat each athlete more fairly when placing a bet on the prediction for the ranking of each athlete in the target competition, and thus the interest of betting is improved and betting can be promoted.

Note that the information processing method of the present invention is implemented by the information processing apparatus alone or a combination (i.e., information processing system) of the information processing apparatus and the terminal on the user side. Here, the information processing apparatus includes a computer, and may be, for example, a server computer for application service provider (ASP), software as a service (SaaS), platform as a service (PaaS), or infrastructure as a service (IaaS). In this case, since the above-described series of information processing (excluding input and display of information) is executed by the server computer, the terminal on the user side is only required to input information to be passed to the server computer and display information distributed from the server computer.

A program of the present invention is a program to be executed by a computer, the program causing a computer to receive a bet on a prediction for ranking of each athlete of a plurality of athletes in a target competition in which the athletes participate, causing a computer to acquire an activity value of each of the athletes in the target competition, and causing a computer to determine whether or not prediction content of the received bet was right in view of ranking of each of the athletes in the target competition determined based on the activity value of each of the athletes in the target competition and a correction condition for each of the athletes with respect to the activity value. By causing a computer to execute such a program, it is possible to treat each athlete more fairly when placing a bet on the prediction for the ranking of each athlete in the target competition. As a result, the interest of betting is improved and betting can be promoted.

Note that the above-described program may be acquired by being read from a computer-readable recording medium, or may be acquired by being received (downloaded) via a network such as the Internet or an intranet.

### Other Embodiments

While the information processing apparatus, the information processing method, and the program of the present invention have been described above with specific examples, the above-described embodiments are merely examples, and there can be other embodiments.

In the above embodiments, the server 10 functions as the information processing apparatus of the present invention, but some of the functions of the server 10 may be included in the user terminal 12. For example, the warning unit 36 may be included in the user terminal 12. In that case, if the bettor designates two or more players falling under the above-described condition (1) or (2) when placing a bet, the user terminal 12 executes warning processing for the bettor, and outputs a warning message, a warning sound, or the like.

The above embodiments assume a case where a bet for the game is placed before the target competition is held, specifically, by the time point of start of the game, but the present invention is not limited thereto. For example, in a time zone (i.e., during the game) from after the start of the game to a time point before the end of the game, it may be possible to place a bet on the ranking of each athlete in the game.

In the above embodiments, the addition condition as a correction condition is set based on the performance activity value of each player in previously held games, specifically, the average appearance time per game and the average score, but the present invention is not limited thereto. For example, the addition condition of each player may be set based on the history (carrier), age, physique, position in the game, and the like of each player. Alternatively, the addition condition of each player may be set based on the number of times the ranking based on the score has been ranked high so far (i.e., the number of games where the player is ranked high in the score ranking).

### DESCRIPTION OF SYMBOLS

10 server (information processing apparatus, computer)
12 user terminal
14 communication network
21 processor
22 memory
23 communication interface
24 storage
25 input device
26 output device
27 bus
31 player information storage unit
32 condition storage unit
33 update unit
34 reception unit
35 betting storage unit
36 warning unit
37 acquisition unit
38 prediction hit determination unit
39 reward provision unit
B1, B2, B3, B4 selection button in betting form
B5 betting button
B6 decision button
S betting system

1. An information processing apparatus comprising a processor:
the processor being configured to:
receive a bet on a prediction for ranking of each athlete of a plurality of athletes in a target competition where the athletes participate;
acquire an activity value of each of the athletes in the target competition; and
determine whether or not a prediction content of the bet received was right, in view of ranking of each of the athletes in the target competition determined based on the activity value of each of the athletes in the target competition and a correction condition for each of the athletes with respect to the activity value.

2. The information processing apparatus according to claim 1, wherein the processor further determines a reward according to a betting value paid by a bettor when placing the bet and provides the reward to the bettor in a case where prediction content of the bet was right.

3. The information processing apparatus according to claim 1, wherein
when the athletes with activity values in a target competition satisfying a predetermined condition are specific athletes, the processor determines whether or not prediction content of the bet was right based on ranking of each of the specific athletes in the target competition determined based on the activity value of each of the specific athletes in the target competition and the correction condition corresponding to the specific athlete.

4. The information processing apparatus according to claim 1, wherein
the activity value is an achievement value of each of the athletes in the target competition, and
the correction condition is an addition condition for the achievement value.

5. The information processing apparatus according to claim 1, wherein
the processor notifies of a plurality of registered athletes preliminarily registered in a state of being able to be designated, and
the processor receives the bet indicating a designation result as to the registered athlete whose ranking in the target competition is predicted to be a set ranking.

6. The information processing apparatus according to claim 1, comprising a storage device that stores the correction condition,
wherein the storage device stores the correction condition set for each of the athletes according to a performance activity value of the each athlete in a previously held competition.

7. The information processing apparatus according to claim 6, wherein the processor updates the correction condition stored in the storage device,
wherein in a case where the target competition is held in each of a plurality of unit periods set within a predetermined period, the processor updates the correction condition for each of the athletes in each of the unit periods.

8. The information processing apparatus according to claim 1, wherein the processor executes warning processing for a bettor who placed a bet when the processor receives the bet in which two or more athletes having a predetermined relationship are designated, in a case where the bet is made by designating as many athletes whose rankings in the target competition are predicted to be any ranking in a set ranking group as a number according to the set ranking group.

9. The information processing apparatus according to claim 8, wherein
the target competition is a game of team competition in which two or more teams compete for a better score, and
the processor executes the warning processing for the bettor when the processor receives the bet in which two or more athletes having a relationship falling under a condition (1) below are designated,
Condition (1): Two or more athletes belong to a same team and have a same position in the game.

10. The information processing apparatus according to claim 8, wherein
the target competition is a game of team competition in which two or more teams compete for a better score, and
the processor executes the warning processing for the bettor when the processor receives the bet in which two or more athletes having a relationship falling under a condition (2) below are designated,
Condition (2): Each of two or more athletes belongs to a same team and falls under limited athletes a number of whom allowed to participate in each team in one game is limited, and the number of athletes falling under the limited athletes exceeds a predetermined number.

11. An information processing method, wherein
a computer receives a bet on a prediction for ranking of each athlete of each athlete of a plurality of athletes in a target competition in which the athletes participate,
a computer acquires an activity value of each of the athletes in the target competition, and
a computer determines whether or not prediction content of the received bet was right in view of ranking of each of the athletes in the target competition determined based on the activity value of each of the athletes in the target competition and a correction condition for each of the athletes with respect to the activity value.

12. An information processing system comprising:
an information processing apparatus comprising a processor, and
a user terminal,
wherein the user terminal is operated in placing a bet on a prediction for ranking of each athlete of a plurality of athletes in a target competition in which the athletes participate,
wherein the processor is configured to:
receive the bet through communication with the user terminal,
acquire an activity value of each of the athletes in the target competition, and
determine whether or not prediction content of the received bet was right in view of ranking of each of the athletes in the target competition determined based on the activity value of each of the athletes in the target competition and a correction condition for each of the athletes with respect to the activity value.
